(19) United States
(12) Patent Application Publication
(10) Pub. No.: US 2011/0148888 A1
(43) Pub. Date: Jun. 23, 2011

(54) METHOD AND APPARATUS FOR CONTROLLING MULTIPLE DISPLAY PANELS FROM A SINGLE GRAPHICS OUTPUT

(76) Inventors: Robert A. Jacobs, Portland, OR (US); Jorge U. Martinez, Beaverton, OR (US)

(21) Appl. No.: 12/646,843

(22) Filed: Dec. 23, 2009

(51) Int. Cl. G06F 15/16

(52) U.S. Cl. 345/502

(57) ABSTRACT

Techniques for providing image information in a single graphics pipe for operation of a plurality of display panels, where a displaying of an image represented by data in the single graphics pipe is to span the plurality of display panels. In an embodiment, the plurality of display panels is represented to an operating system as a single display. In another embodiment, a scale factor may be determined for the representation of the plurality of display panels to conform to one or more criteria of the operating system.

### BACKGROUND

1. Technical Field

Embodiments generally relate to graphics processing for displaying of an image by multiple display panels. More particularly, various embodiments relate to providing image information to multiple display panels via a single graphics render output and/or a single graphics bus.

2. Background Art

In computing, techniques for dividing the displaying of a video image across multiple display panels has traditionally relied upon the use of multiple graphics rendering outputs, each graphics processing unit corresponding to a different respective one of the multiple display panels. According to such techniques, a computer operating system (OS) provides, via different respective graphics channels, different graphics data to each of the graphics rendering outputs. Each of the graphics rendering outputs processes its different respective graphics data to generate respective render data. The graphics rendering outputs further process their respective render data, each to generate respective video data for controlling display operations of a corresponding display panel. The multiple graphics rendering outputs each provide their different respective video data to their corresponding display panels via different respective graphics output interfaces.

The above described technique has significant processing and hardware requirements which are attendant with providing multiple graphics rendering outputs for different respective display panels. Moreover, in converting render data into video data, the graphics rendering outputs each incur a processing load which is at the expense of resource availability for performing rendering calculations. As successive generations of video technologies require increasing video data throughput, platforms are increasingly sensitive to limits on resource availability for graphics processing.

### BRIEF DESCRIPTION OF THE DRAWINGS

Various embodiments are illustrated by way of example, and not by way of limitation, in the figures of the accompanying drawings and in which:

FIG. 1 is a block diagram illustrating select elements of a platform for exchanging image information according to an embodiment.

FIG. 2A is a block diagram illustrating a configuration of display panels to receive image information according to an embodiment.

FIG. 2B is a block diagram illustrating a representation of multiple display panels according to an embodiment.

FIG. 3 is a block diagram illustrating select elements of a graphics controller according to an embodiment.

FIG. 4 is a block diagram illustrating select elements of a graphics controller according to an embodiment.

FIG. 5 is a block diagram illustrating select elements of a technique to rotate render data according to an embodiment.

FIG. 6 is a timing diagram for signals controlling multiple display panels according to an embodiment.

FIG. 7 is a flow diagram illustrating select elements of a method to exchange image information according to an embodiment.

### DETAILED DESCRIPTION

Various embodiments relate to techniques, apparatus and systems by which a computer platform sends video data to multiple display panels via a single graphics bus. The video data may represent an image, where a displaying of the image is to span multiple display panels.

For the sake of clarity in demonstrating certain features of various embodiments, “graphics data” as used herein refers to data to be operated on by a rendering computation—e.g. a computation performed by a graphics processing engine. Furthermore, “render data” as used herein refers to a result of one or more rendering computations performed on graphics data. Further still, “video data” as used herein to refer to data—e.g. generated by converting a format of image data—to be provided to a display panel for controlling a displaying by the display panel. Graphics data, render data and/or video data may be generically referred to herein as “image information”.

Embodiments of the invention may be implemented on a computer platform including an operating system (OS) to provide graphics data for processing by a graphics processing engine (GPE) of the platform. A GPE may include, for example, one or more processing cores of a graphics processing unit. The OS may send graphics data based on information representing a characteristic of a display panel, where the OS provides graphics information as if an image corresponding to the graphics information were to be displayed by the display panel. For example, the OS may be provided with information representing dimensions of a display, where the OS uses the represented dimensions to determine whether and/or how graphics data is to be provided. The OS may require that the represented dimensions satisfy to one or more criteria—e.g. a minimum display height and/or a minimum display width. With the represented dimensions satisfying such criteria, the graphics data may be received at the GPE in a single graphics data channel, where each of the multiple display panels is to be controlled based on information exchanged in the single graphics data channel.

Multiple display panels may be arranged in a configuration for a displaying of the image which spans the multiple display panels. A display panel may include any of a variety of display means of a computing device including, but not limited to a desktop computer monitor, a laptop display screen, a cell phone display screen, a television, a remote panel over a wireless or other network connection, or any of a variety of similar screen devices configured to display a video image. A configuration of multiple panel displays may be characterized by a total height dimension which, for example, includes a sum of respective height dimensions (e.g. in pixels) of one or more of the multiple panel displays. Alternatively or in addition, a configuration of multiple panel displays may be characterized by a total length dimension which, for example, includes a sum of respective length dimensions (e.g. in pixels) of one or more of the multiple panel displays. The OS may be provided with information representing one or more dimensions of a display, wherein the information is based on the total height dimension and/or the total width dimension for the configuration of multiple display panels. As used herein, “height” and “width” are understood to refer to orthogonal dimensions of a display area of a display panel—e.g. as measured in pixels. Unless indicated otherwise herein, embodiments are not limited to any particular dimension being either a “height” dimension or a “width” dimension.

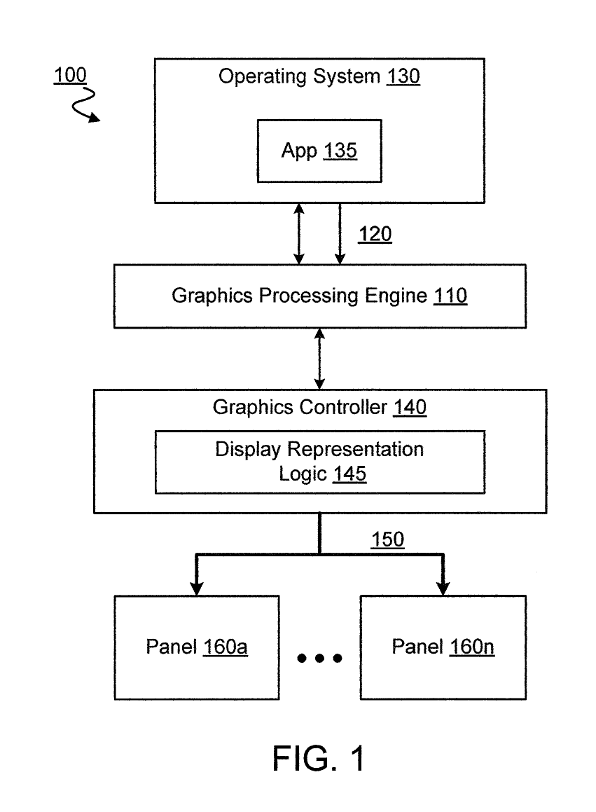

FIG. 1 illustrates select elements of a platform 100 to exchange image information via a single graphics render output and/or a single graphics bus for operation of multiple display panels, according to an embodiment. Platform 100 may include any of a variety of computing devices including, but not limited to a desktop, laptop, notebook, work station, handheld device, or other similar device. Platform 100 may include an OS 130 to run an application 135—e.g. a gaming application etc.—which generates graphics data for later rendering and display. The graphics data of application 135 may be sent, directly or indirectly, to a single graphics channel 120 which feeds data to a GPE 110 of platform 100. The graphics data may be used for generating an image, where a displaying of the image is to span multiple display panels 160a, . . . , 160n of platform 100.

Display panels 160a, . . . , 160n may include any of a variety of combinations of display means whose operations to display a video image are controlled at least by video data received via a shared graphics data bus 150 of platform 100. Although shown on platform 100, one or more of display panels 160a, . . . , 160n may, in various embodiments, include an independently operable platform—e.g. a separate computer, cell phone, or other similar display device—which includes a display means configurable to be controlled as a peripheral of platform 100 via graphics data bus 150.

GPE 110 may perform any of a variety of combinations of rendering computations with the graphics data. Such rendering calculations may, for example, calculate whether and/or how particular image elements are to be included in a rendered image. By way of illustration and not limitation, rendering calculations may include one or more of calculating geometry, perspective, texture, shading, reflection, blur, and the like. Render data resulting from the calculations may represent an image, where a displaying of the image as a whole is to span the panels 160a, . . . , 160n. For example, each display panels 160a, . . . , 160n may be configured to display a different respective portion of an image which is based on rendering calculations by GPE 110—e.g. performed on graphics received by GPE 110 only through a single graphics channel.

GPE 110 may provide to a graphics controller 140 of platform 100 render data which includes a result of one or more of the rendering calculations. A graphics controller may include any of a variety of combinations of hardware means and/or software means to variously implement the techniques described herein. For example, a graphics controller may include one or more of an application specific integrated circuit (ASIC), a field programmable gate array (FPGA), etc. A graphics controller may also be incorporated into a larger integrated circuit. Graphics controller 140 may perform a conversion of the received render data into video data having a format suitable for controlling one or more display operations of panels 160a, . . . , 160n. The graphics controller 140 and GPE 110 may be connected by a bus typically used for video output, such a buss according to an interface standard such as Digital Visual Interface (DVI), High-Definition Multimedia Interface (HDMI), DisplayPort or by any other interface standard suitable for high speed video data.

Platform 100 may, in various embodiments, include display representation logic 145 to present to OS 130 a representation of a display, where OS 130 uses the representation to determine how graphics data is to be provided to graphics channel 120. Display representation logic 145 may directly or indirectly provide such a representation to OS 130—e.g. via GPE 110. OS 130 may request or otherwise require information which specifies or otherwise indicates one or more dimensions of a display. Representational information may be presented at system initialization time, for example, and transferred from a configuration memory space to the graphics device driver. For example, the Enhanced Extended Display Identification Data (EEDID) method v1.3, may be used to provide the OS 130 with basic information of a display panel—such as dimensions, supported resolutions, native resolution, etc. Presentation of such information by display representation logic 145 may constitute a representation of display panels 160a, . . . , 160n to OS 130 as a single display.

OS 130 may then generate graphics data associated with an image, where the graphics data is formatted as if all of the image were to be displayed on the represented display. In actuality, such a represented display may not actually exist, and OS 130 may have no indication that a displaying of the image in question is actually to span multiple display panels 160a, . . . , 160n. Alternatively or in addition, GPE 110 may have no indication that it is rendering graphics data for a later displaying of an image which spans multiple display panels. Although shown in graphics controller 140, display representation logic 145 may, according to various embodiments, reside in another location of platform 100—e.g. GPE 110.

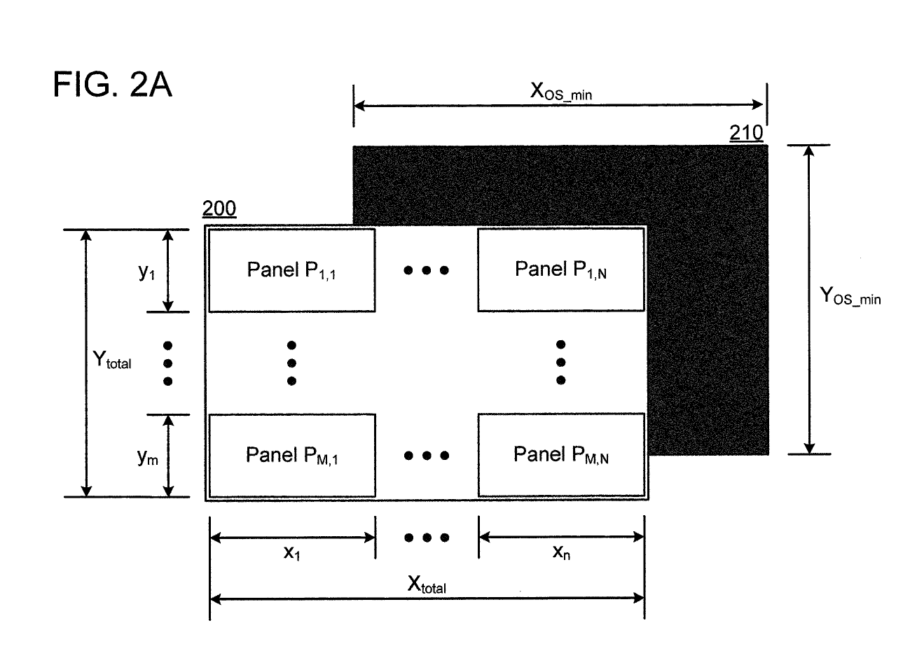

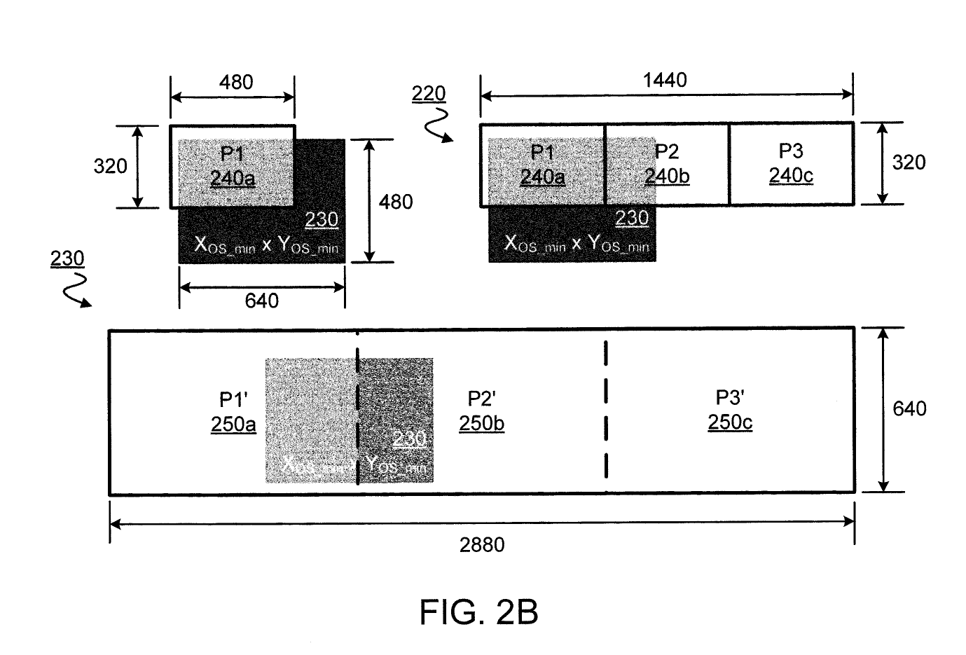

FIG. 2A illustrates select elements of a configuration 200 of multiple display panels operating according to an embodiment. Configuration 200 may, for example, represent an arrangement of panels 160a, . . . 160n. Configuration 200 may include two or more display panels arranged into M rows by N columns. It is understood that configuration 200 may include any of a variety of additional or alternative arrangements of multiple display panels.

The configuration 200 may be characterized by a total height dimension Yₜₒₜₐₗ which, for example, includes a sum of respective height dimensions of one or more of the multiple panel displays. For example, a height y₁ of a first row including panels P_{1,1}, . . . , P_{1,N} and a height yₘ of an Mth row having panels P_{M,1}, . . . , P_{M,N} may be included in the total height Yₜₒₜₐₗ of configuration 200. Additionally of alternatively, configuration 200 may be characterized by a total width dimension Xₜₒₜₐₗ which, for example, includes a sum of respective width dimensions of one or more of the multiple panel displays. For example, a width x₁ of a first column having panels P_{1,1}, . . . , P_{M,1} and a width x₁, of an Nth column having panels P_{1,N}, . . . , P_{M,N} may be included in the total width Xₜₒₜₐₗ of configuration 200.

In order to control operation of the display panels in configuration 200, information may need to be provided to an operating system which indicates a format for graphics data to be provided to a graphics processing engine. The information may provide to the operating system a representation of a display, where the operating system thereafter provides graphics data for an image as if the image were to be displayed entirely within that display. In the illustrative case of platform 100, OS 130 may require information indicating one or more dimensions of a display in order to provide graphics data to GPE 110. The operating system may have minimum criteria for the display being represented to it. For example, the operating system may require that a display receiving some form of graphics data have at least a minimum width X_{OS}_{_{—}}ₘᵢₙ—e.g. as measured in pixels. Additionally or alternatively, the operating system may require that the display receiving such graphics data have at least a minimum height Y_{OS}_{_{—}}ₘᵢₙ—e.g. as measured in pixels. A combination of such criteria may describe or otherwise determine a minimum area 210 which must be represented to the operating system in order for graphics data to be provided to a graphics processing engine.

FIG. 2B illustrates techniques for determining a display 230 to be represented to an operating system, according to an embodiment. A representation of display 230 may be provided to an operating system in order to facilitate the operating system—e.g. an application run by the operating system—generating graphics data for rendering and display. For example, information from display representation logic 145 may be directly or indirectly provided to OS 130 to represent multiple display panels 160a, . . . , 60n to OS 130 as a single display panel 230.

Display representation logic 145 may include or otherwise avail of logic to identify a minimum width X_{OS}_{_{—}}ₘᵢₙ required of a display by the operating system and/or a minimum height Y_{OS}_{_{—}}ₘᵢₙ required of a display by the operating system. In the illustrative case of FIG. 2B, a display panel P1 240a has a width of 480 pixels and a height of 320 pixels. The operating system in question requires that images be displayed in at least a minimum display area 230 characterized by a minimum width X_{OS}_{_{—}}ₘᵢₙ and a minimum height Y_{OS}_{_{—}}ₘᵢₙ.

A desired displaying of an image may span multiple display panels P1 240a, P2 240b, P3 240c which are in a particular configuration 200. The respective dimensions of multiple display panels P1 240a, P2 240b, P3 240c, and their respective arrangement with respect to one another in configuration 200, may determine that configuration 220 as a whole fails to satisfy one or more minimum display dimensions required by an operating system. For example, configuration 220 may have a total width Xₜₒₜₐₗ of 1440 pixels which satisfies the required minimum width X_{OS}_{_{—}}ₘᵢₙ of 640 pixels. However, configuration 220 may have a total height Yₜₒₜₐₗ total of 320 pixels which fails to satisfy the required minimum height Y_{OS}_{_{—}}ₘᵢₙ of 480 pixels.

In order to represent to the operating system a display which satisfies the requirements of minimum display area 230, display representation logic may present to the operating system information indicating display height and/or display width dimensions which are based on a scaling of the total width Xₜₒₜₐₗ and/or total height Yₜₒₜₐₗ of configuration 220. For example, display representation logic 145 may calculate or otherwise determine a minimum scaling—e.g. a minimum integer scaling—of the total dimensions of configuration 220 which is sufficient to cover minimum display area 230. In the illustrative case of FIG. 2B a scaling of integer two (2) is applied to generate information describing a display 230 representing a combination of areas P1′ 250a, P2′ 250b, P3 250c which are, respectively, a scaling of the areas of display panels P1 240a, P2 240b, P3 240c. The represented display 230 has a total width of 2880 pixels and a total height of 640 pixels. It is understood that configuration 200 may include any of a variety of additional or alternative numbers and/or arrangements of multiple display panels. It is also understood that any of all of the display panels in configuration 200 may be characterized by any of a variety of combinations of alternative height and/or width dimensions.

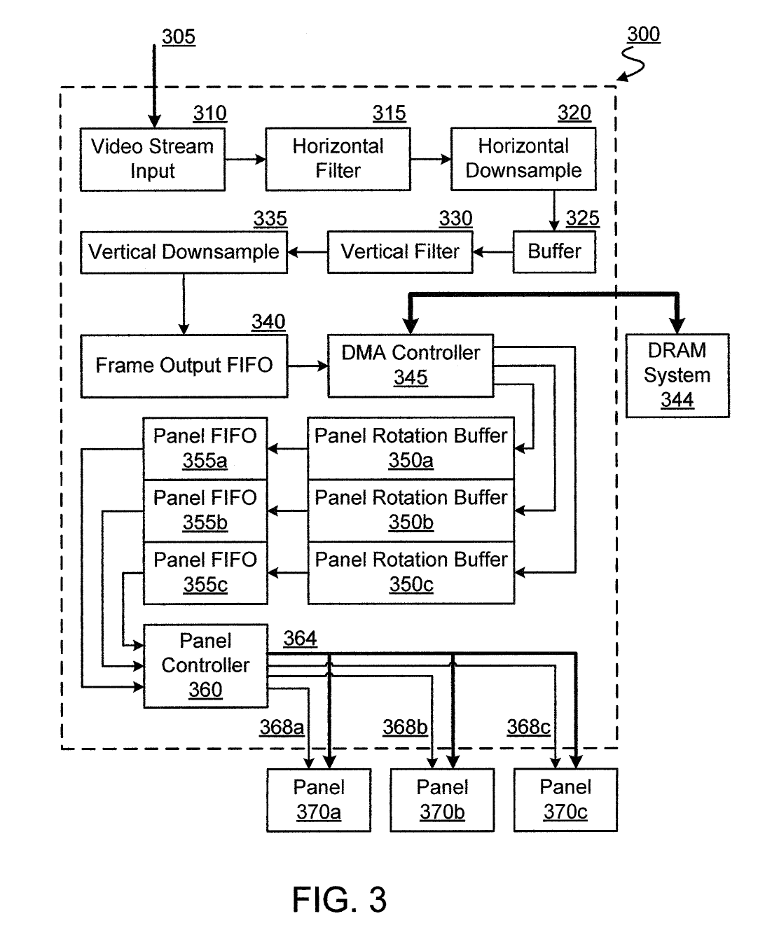

FIG. 3 illustrates select elements of a graphics controller 300 according to an embodiment, the graphics controller 300 to exchange information in a single graphics render output and/or a single graphics bus for operation of multiple display panels. Graphics controller 300 may include one or more features described herein with respect to graphics controller 140, for example. A single input graphics render stream 305 may provide to a video stream input 310 of graphics controller 300 render data rendered by a GPE—e.g. GPE 110. Input graphics render stream 305 may provide render data for a single image, where an eventual display of the image is to span multiple display panels 370a, 370b, 370c.

In an embodiment, video stream input 310 may buffer a flow of render data from input graphics render stream 305. Graphics controller 300 may also include an interface (not shown) for control information to be sent to a GPE and/or an OS—e.g. in a sideband control channel. By way of illustration and not limitation, graphics controller 300 may further include control I/O means to directly or indirectly provide to an operating system a representation of display panels 370a, 370b, 370c as a single display panel. For example, video stream input 310 may include display representation logic 145 and/or communicate information on behalf of display representation logic 145. A displaying of an image which spans display panels 370a, 370b, 370c may be according to a particular configuration of display panels 370a, 370b, 370c, where the configuration is characterized by a given width and/or height—e.g. measured in pixels.

A scaled up representation of the configuration as a single, larger, display may be provided to an operating system of the platform in order to accommodate minimum display requirements of the operating system. As a result, render data provided via input graphics render stream 305 may be for a much larger display area than that which is provided by the intended configuration of panels 370a, 370b, 370c. In order to account for the disparity between the size of the configuration of panels 370a, 370b, 370c and the amount of graphics data originally generated—the amount of resulting render data received via input graphic render stream 305 may need to be reduced. For example, video stream input 310 may send render data through various filtering and downsampling means.

In the illustrative case of FIG. 3, a horizontal filter 315 may perform an anti-aliasing low-pass filtering of horizontal lines of the render data. The resulting horizontally-filtered render data may then be sent to a horizontal downsample unit 320 to reduce a sampling rate of the horizontal components of the horizontally-filtered render data. This filtering and downsampling in commonly referred to as “decimation”—although the factor by which data may be downsampled can vary. For example, in an embodiment downsampling may be by a factor of 2:1.

The horizontally downsampled render data may then be subjected to subsequent vertical filtering and downsampling. For example, horizontal downsample unit 320 may store the horizontally downsampled render data to a buffer 325, which then sends the data to a vertical filter 330 and vertical downsample unit 335. The vertical processing by vertical filter 330 and vertical downsample unit 335 may generally correspond to the signal processing by horizontal filter 315 and horizontal downsample unit 320. More particularly, filtering by vertical filter 330 may be similar to that of horizontal filter 315, except that anti-aliasing low-pass filtering is instead applied by vertical filter 330 with respect to vertical lines of the horizontally-downsampled render data. Moreover, downsampling by vertical downsample unit 335 may be similar to that of horizontal downsample unit 320, except that the downsampling is instead applied by vertical downsample unit 335 with respect to vertical lines of the horizontally-downsampled render data.

It is understood that, in various embodiments, vertical filtering-downsampling of render data may be performed before horizontal filtering-downsampling of said render data. In various embodiments, horizontal (and/or vertical) low-pass filtering may be implemented so as to assure that the Shannon-Nyquist sampling theorem is not substantially violated in any subsequent application of horizontal (and/or vertical) downsampling.

Horizonally and vertically downsampled render data for an entire frame of an image may then be stored. By way of illustration and not limitation, a frame output first-in-first-out (FIFO) buffer 340 may receive data output by the vertical downsample unit 335 for subsequent storing in a dynamic random access memory (DRAM). A direct memory access (DMA) controller 345 of graphics controller 300 may move data from frame output FIFO 340 to a DRAM system 344 separate from the graphics controller 300. In an embodiment, DRAM system 344 may include a synchronous DRAM (SDRAM).

The downsampled render data for an entire image frame may then be read from DRAM system 344 by DMA controller 345 in a particular sequence for determining multiple data portions, each data portion specific to a respective one of the display panels 370a, 370b, 370c. By way of illustration and not limitation, DMA controller 345 may selectively write frame data from DRAM memory system 344 to various panel rotation buffers, each panel rotation buffer corresponding to a different respective display panel. For example, DMA controller 345 may write different respective data to panel rotation buffers 350a, 350b, 350c which correspond, respectively, to display panels 370a, 370b, 370c. Data may then be read from panel rotation buffers 350a, 350b, 350c and written to respective panel FIFOs 355a, 355b, 355c. To provide for a rotation of image information, an order in which data is written into a given panel rotation buffer may, in various embodiments, be different from an order in which the data is read from that panel rotation buffer.

The successive writing data to and reading data from DRAM system 344 and panel rotation buffers 350a, 350b, 350c may result in panel FIFOs 355a, 355b, 355c each storing data in an order which is suitable for the respective orientations of displays 370a, 370b, 370c in a desired configuration. The data stored in panel FIFOs 355a, 355b, 355c may then be provided to a panel controller 360 for generating video data for controlling display operations of display panels 370a, 370b, 370c. The graphics controller 300 may connect to the display panels 370a, 370b, 370c via a parallel RGB interface, where each pixel is represented by a 6-bit number for each of the video colors (Red, Green, Blue). All of the display panels may receive their unique clock—e.g. 368a, 368b, 368c—which is a delayed, divided-down version of an internal master clock of graphics controller 300. The graphics controller 300 may further provide other controlling signals (not shown) for frame/video timing such as Horizontal Sync (Hsync), Vertical Sync (Vsync), and Data Enable (DEN).

In an embodiment, panel controller 360 may send video data in a single output graphics data bus 364 to each of display panels 370a, 370b, 370c. Although they share the same data signals, the display panels 370a, 370b, 370c may each receive their own clock signals. To generate video data, panel controller 360 may determine a sequencing of multiple data portions to be sent in output graphics data bus 364, each of the multiple data portions specific to a different respective one of display panels 370a, 370b, 370c. In various embodiments, panel controller 360 may further provide respective clock signals 368a, 368b, 368c to display panels 370a, 370b, 370c. Clock signals 368a, 368b, 368c may, for example, control reading of the respective data portions in output graphics data bus 364 by display panels 370a, 370b, 370c.

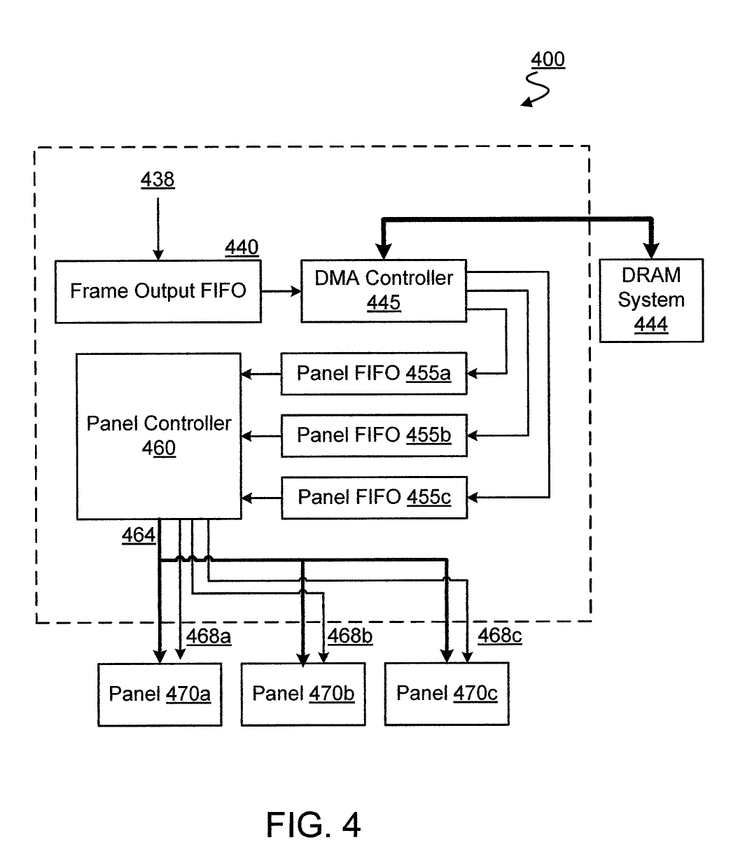

FIG. 4 illustrates select elements of a graphics controller 400 according to an alternate embodiment, the graphics controller 400 to exchange information in a single graphics render output and/or a single graphics data bus for operation of multiple display panels. Graphics controller 400 may include some or all of the features of graphics controller 140, for example. In an embodiment, a frame output FIFO 440 of graphics controller 400 may receive render data 438 representing an image, where the render data 438 is in a format which can be readily sampled for a displaying of the image which spans multiple panels 470a, 470b, 470c. For example, render data 438 may be the result of previous decimation operations, such as those described herein with respect to graphics controller 300.

Frame output FIFO 440 may store render data for subsequent storing in a dynamic random access memory (DRAM). A DMA controller 445 of graphics controller 400 may move data from frame output FIFO 440 to a DRAM system 444 separate from graphics controller 400. In an embodiment, DRAM system 444 may include a synchronous DRAM (SDRAM). The render data for an entire image frame may then be read from DRAM system 444 by DMA controller 445 in a particular sequence for determining multiple data portions of video data, each portion specific to a respective one of the display panels 470a, 470b, 470c.

By way of illustration and not limitation, DMA controller 445 may selectively write frame data from DRAM memory system 444 to respective panel FIFOs 455a, 455b, 455c which correspond, respectively to display panels 470a, 470b, 470c. A panel controller 460 coupled to panel FIFOs 455a, 455b, 455c may read the render data stored therein to determine a sequencing of multiple data portions for communication in a single graphics data bus.

In the illustrative case of FIG. 4, a reading of render data from DRAM memory system 444 in a particular order may in itself allow panel controller 460 to access a desired order of data in panel FIFOs 455a, 455b, 455c. For example, a rotation of image information—e.g. by various reading to and writing from panel rotation buffers 350a, 350b, 350c—may not be performed if a configuration of display panels 470a, 470b, 470c does not require such rotation. This may occur, for example, if the multiple display panels are oriented in an intended configuration so that they are to display row/column information in an orientation which already corresponds to how row/column information for the overall image is stored by DRAM system 444.

With panel FIFOs 455a, 455b, 455c storing render data in a suitable order for panel controller 460, the render data may then be used to generate video data for controlling display panels 470a, 470b, 470c. Generating the video data may include, for example, determining a sequencing of data portions which are each specific to a respective one of multiple display panels. Video data comprising the sequence of data portions may then be exchanged via a single output graphics data bus 464 which is provided to each of display panels 470a, 470b, 470c. Panel controller 460 may further provide respective clock signals 468a, 468b, 468c to display panels 470a, 470b, 470c. Clock signals 468a, 468b, 468c may, for example, control reading of the respective data portions in output graphics data bus 464 by display panels 470a, 470b, 470c.

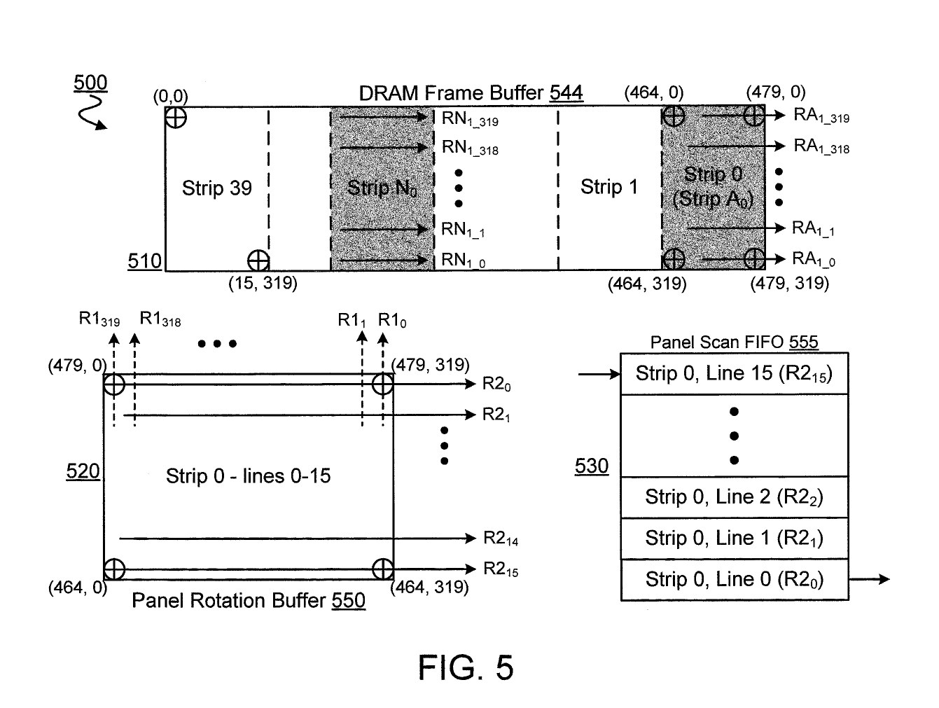

FIG. 5 illustrates select elements of a sequence 500 for rotating image information according to an embodiment. Sequence 500 may be performed by graphics controller 300, for example. Sequence 500 may include, at 510, reading a frame of render data from a DRAM frame buffer 544—e.g. a DRAM buffer of DRAM system 344, for example. The render data may be stored in rows and columns of DRAM frame buffer 544—e.g. corresponding to rows and columns of the image. By way of illustration and not limitation, 320 rows and 480 columns of render data as stored in a DRAM system may represent a “landscape” orientation (width greater than height) of an image to be displayed. However, a displaying of the image may span display panels which are configured to display their respective portions of the image in respective “portrait” orientations (height greater than width).

For each of the multiple display panels, different respective read bursts are performed to read respective strips of the render data. For example, a first read burst for a display panel A (not shown) may perform successive row-wise reads RA₁_{_{—}}₀, RA₁_{_{—}}₁, . . . , RA₁_{_{—}}₃₁₈, RA₁_{_{—}}₃₁₉ of a strip A₀, where the data read in the first read burst is written to a panel rotation buffer 550 corresponding to display panel A. Each row-wise read may span only a portion of a given row—e.g. 16 pixels of a 480 pixel wide row. Alternatively or in addition, a second read burst for another display panel N (not shown) may perform successive row-wise reads RN₁_{_{—}}₀, RN₁_{_{—}}₁, . . . , RN₁_{_{—}}₃₁₈, RN₁_{_{—}}₃₁₉, of a strip N₀, where the data read in the second read burst is written to another panel rotation buffer (not shown) corresponding to display panel N. The respective reading of render data strips for different display panels may be performed either sequentially or in parallel, according to various embodiments.

Sequence 500 may further include, at 520, render data being variously written to and read from the panel rotation buffer 550. For example, the successive—e.g. row-wise—reads RA₁_{_{—}}₀, RA₁_{_{—}}₁, . . . , RA₁_{_{—}}₃₁₈, RA₁_{_{—}}₃₁₉, of strip A₀ may be written—e.g. column-wise—as writes R1₀, R1₁, . . . , R1₃₁₈, R1₃₁₉ into panel rotation buffer 550. The render data stored as writes R1₀, R1₁, . . . , R1₃₁₈, R1₃₁₉ may then be sent to a panel scan FIFO 555 corresponding to the display panel A. For example, data written column-wise to panel rotation buffer 550 may be read—e.g. row-wise—from panel rotation buffer 550 as reads R2₀, R2₁, . . . , R2₁₄, R2₁₅.

Sequence 500 may further include, at 530, the render data which is read row-wise from panel rotation buffer 550 being written to panel scan FIFO 555 for later access by a panel controller. In an embodiment, panel rotation buffer 550 is emptied to panel scan FIFO 555 each time a single strip has been completely written to panel rotation buffer 550. This allows panel rotation buffer 550 to be fairly small in size, and limits the load of performing very large column write, row read operations.

The rotated render data for respective strips may be successively pushed from panel scan FIFO 555 to a panel controller—e.g. panel controller 360—for generating video data used to control display operations of the display A corresponding to panel scan FIFO 555. In an embodiment, the panel controller may successively read from multiple panel scan FIFOs, each corresponding to a different respective display panel. The panel controller may generate from the render data in the multiple panel scan FIFOs a sequence of multiple portions of video data, each data portion specific to a different respective display panel. The panel controller may then provide the sequence of multiple data portions in a single graphics data bus which is provided to each of the display panels.

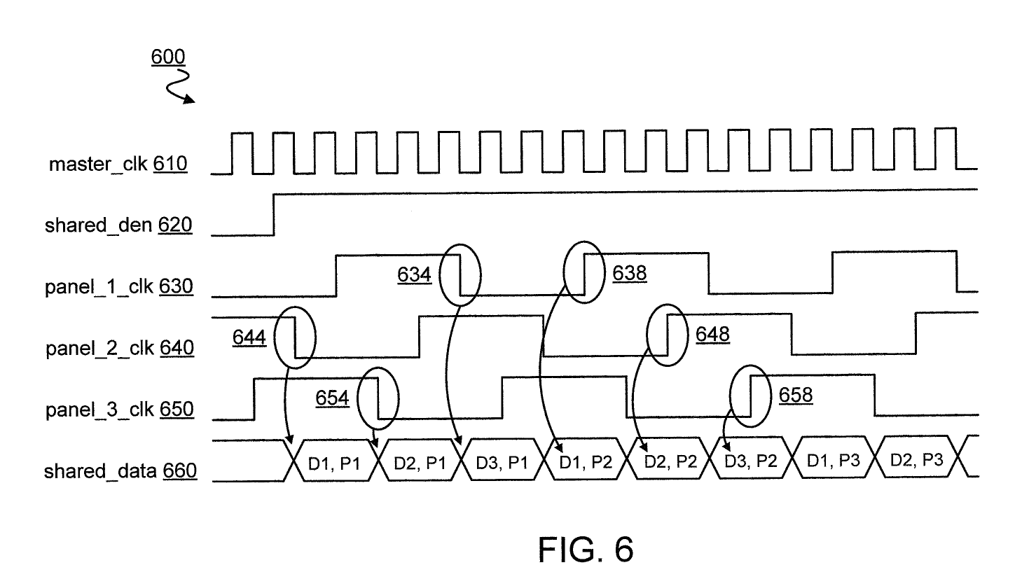

FIG. 6 is a timing diagram 600 illustrating select elements of an exchange of video information in a single graphics data bus which is provided to multiple display panels according to an embodiment. Timing diagram 600 may, for example, represent select element of an exchange between graphics controller 140 and panels 160a, . . . , 160n.

A master clock signal master clk 610 within a graphics controller—e.g. within panel controller 360—may be used to generate different clock signals, each to be provided to a different respective display controlled by the panel controller. By way of illustration and not limitation, a first panel clock signal panel_1_clk 630, a second panel clock signal panel_2_clk 640 and a third panel clock signal panel_3_clk 650 may each be provided to a different respective display panel, each clock signal to control when the corresponding display panel is to read from a single graphics data bus. It is understood that timing diagram 600 may include any of a variety of combinations of additional and/or alternative clock signals for multiple display panels, according to various embodiments. A shared data enable signal shared_den 620 may also be provided to indicate when shared data signal shared_data 660 of the single graphics data bus is ready for sequential reading the different display panels according to their respective clock signals 630, 640, 650.

Transitions of the display clock signals may be coordinated with shared_data 660 transitioning from carrying data to be read by one display panel to carrying data to be read by another display panel. In an illustrative case of FIG. 6, a transition 644 of panel_2_clk 640 may be synchronized with shared_data 660 transitioning to carrying a data portion specific to a first display. For example, transition 644 may be concurrent with shared_data 660 transitioning to carrying a first pixel D1, P1 of a portion D1 of an image, the portion D1 to be displayed by the first display. Alternatively or in addition, a transition 634 of panel_1_clk 630 may be concurrent with shared_data 660 transitioning to carrying a first pixel D3, P1 of a portion D3 of the image, the portion D3 to be displayed by a third display. Alternatively or in addition, a transition 654 of panel_3_clk 650 may be concurrent with shared_data 660 transitioning to carrying a first pixel D2, P1 of a portion D2 of the image, the portion D2 to be displayed by a second display.

Transitions of the different respective panel clock signals may variously indicate to their corresponding display panels when shared data of the single graphics data bus is to be read. In the illustrative case of FIG. 6, a transition 638 of panel_1_clk 630 may indicate to the first display to read a second pixel D1, P2 of the portion D1 of the image to be displayed by a first display. Alternatively or in addition, a transition 648 of panel_2_clk 640 may indicate to the second display to read a second pixel D2, P2 of the portion D2 of the image to be displayed by a second display. Alternatively or in addition, a transition 658 of panel_3_clk 650 may indicate to the third display to read a second pixel D3, P2 of the portion D3 of the image to be displayed by a third display.

Although particular clock transitions are shown in FIG. 6, it is understood that additional or alternate clock transitions—e.g. low-to-high instead of high-to-low—may be used, depending on a particular implementation chosen. Furthermore, it is understood that a particular clock signal transitioning in sync with a transition of data on shared_data 660 may merely be an artifact of synchronizing clock signals with periods of data stability on shared_data 660.

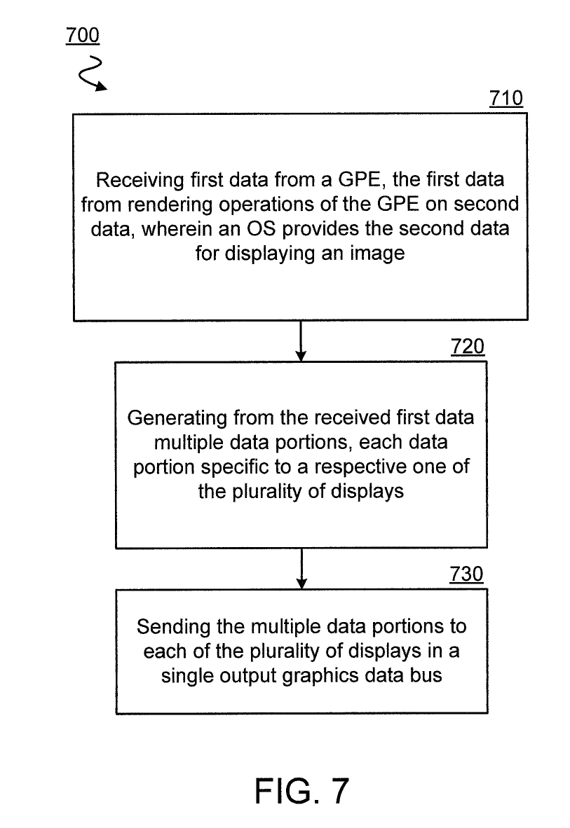

FIG. 7 illustrates select elements of a method 700 according to an embodiment for exchanging information in a single graphics render output and/or a single graphics data bus for operation of multiple display panels. Method 700 may be performed, for example, by one or more mechanisms of platform 100.

Method 700 may include, at 710, receiving—e.g. in a single input graphics render output—first data from a GPE. The first data may include render data generated by the GPE performing one or more rendering operations. In an embodiment, the rendering operations performed by the GPE may be operations performed on second data provided by an operating system of the computer platform including the GPE. For example, the GPE may perform operations on graphics data generated by the OS—e.g. by a gaming or other graphics application run on the OS—and provided directly or indirectly to the GPE. The graphics data may provided to display an image, such as a static digital picture or a single frame of a video sequence. A displaying of the image based on the graphics data may span multiple display panels. The providing of the graphics data by the operating system may be based on a representation made to the OS, e.g. representing the multiple display panels as a single display.

In an embodiment, representing the multiple displays to the OS as a single display may include providing information indicating a total display height of the single display and/or indicating a total display width of the single display. The total display height may be greater than or equal to a minimum display height required by the OS. Alternatively or in addition, the total display width may be greater than or equal to a minimum display width required by the OS.

In an embodiment, a graphics controller implementing method 700 may include means to issue a query as to the minimum display height required by the OS and/or the minimum display width required by the OS. Alternatively or in addition, such a graphics controller may include means to apply a scale factor to a total height and/or to a total width of a configuration of the multiple display panels. The information indicating a total display height and/or a total display width of the represented single display may be based on a scaling of the total height and/or total width of the configuration of the multiple display panels.

Method 700 may, at 720, generate from the received first data multiple data portions, each data portion specific to a respective one of the plurality of displays. The multiple data portions may include multiple portions of video data generated according to any of a variety of combinations of techniques described herein with respect to graphics controller 300 and graphics controller 400, for example.

Method 700 may, at 730, send the multiple data portions in a sequence through a single output graphics data bus. In various embodiments, a graphics controller sending the sequence of video data portions also provides to each of the multiple display panels a different respective clock sequence. The providing of video data and clock signals to the multiple display panels may be performed according to any of a variety of combinations of techniques described herein with respect to graphics controller 300, graphics controller 400 and timing diagram 600, for example.

Techniques and architectures for exchanging image information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of certain embodiments as described herein.

Besides what is described herein, various modifications may be made to the disclosed embodiments and implementations of certain embodiments without departing from their scope. Therefore, the illustrations and examples herein should be construed in an illustrative, and not a restrictive sense. The scope of the invention should be measured solely by reference to the claims that follow.

What is claimed is:

1. A method comprising:
receiving first data from a graphics processing engine (GPE), the first data resulting from rendering calculations by the GPE performed on second data, wherein an operating system (OS) provides the second data for displaying an image;
generating from the received first data multiple data portions, each data portion specific to a respective one of a plurality of display panels; and
sending the multiple data portions to each of the plurality of display panels in a single output graphics data bus.

2. The method of claim 1, wherein the OS provides the second data for generating an image in a single display panel having at least one of:
a total display height greater than or equal to a minimum display height required by the OS, and
a total display width greater than or equal to a minimum display width required by the OS, wherein the OS provides the second data in response to a representation of the plurality of display panels as the single display panel.

3. The method of claim 2, further comprising providing information for the representation of the plurality of display panels as the single display panel, including providing information indicating at least one of the total display height of the single display and the total display width of the single display.

4. The method of claim 2, wherein the plurality of display panels are arranged in a configuration for a displaying of the image which spans the plurality of display panels, and wherein the information indicating at least one of the total display height of the single display and the total display width of the single display includes information based on a total height of the configuration and a total width of the configuration.

5. The method of claim 4, further comprising determining a scale factor for the representation of the plurality of display panels as the single display panel, and wherein a product of the total height of the configuration and the scale factor is greater than or equal to the minimum display height required by the OS, and wherein a product of the total width of the configuration and the scale factor is greater than or equal to the minimum display width required by the OS

6. The method of claim 2, further comprising providing to each of the plurality of display panels a different respective clock signal, each clock signal to indicate to the respective display panel to read from the single output graphics data bus the data portion specific to the respective display panel.

7. The method of claim 2, wherein the generating multiple data portions includes
storing in a memory third data representing all of the image, the third data based on the first data; and
for each display panel of the plurality of display panels,
reading a different respective strip of the third data stored in the memory, and
storing data of the different respective strip to a different respective buffer for the display panel.

8. The method of claim 7, further comprising performing decimating operations on the first data to generate the third data.

9. The method of claim 2, wherein the first data is provided from the GPE in a single graphics render output.

10. An apparatus comprising:
a video input stream module to receive first data from a graphics processing engine (GPE), the first data resulting from rendering calculations by the GPE performed on second data, wherein an operating system (OS) provides the second data for displaying an image;
a panel controller to receive multiple data portions generated from the first data, each of the multiple data portions for a different respective one of a plurality of display panels, the panel controller to determine a sequencing of the multiple data portions, the panel controller further to send the multiple data portions to the plurality of display panels in a single output graphics data bus, the sending according to the sequencing.

11. The apparatus of claim 10, further comprising:
display representation logic to present to an operating system (OS) a representation of the plurality of display panels as a single display panel having at least one of:
a total display height greater than or equal to a minimum display height required by the OS, and
a total display width greater than or equal to a minimum display width required by the OS,
wherein the OS provides the second data in response to a representation of the plurality of display panels as the single display panel.

12. The apparatus of claim 11, wherein the display representation logic to present to the OS the representation of the plurality of display panels as the single display panel includes the display representation logic to provide information indicating at least one of the total display height of the single display and the total display width of the single display.

13. The apparatus of claim 12, wherein the plurality of display panels are arranged in a configuration for a displaying of the image which spans the plurality of display panels, and wherein the information indicating at least one of the total display height of the single display and the total display width of the single display includes information based on a total height of the configuration and a total width of the configuration.

14. The apparatus of claim 11, the panel controller further to provide to each of the plurality of display panels a different respective clock signal, each clock signal to indicate to the respective display panel to read from the single output graphics data bus the data portion specific to the respective display panel.

15. The apparatus of claim 11, further comprising a direct memory access (DMA) controller to store in a memory third data representing all of the image, the third data based on the first data, and wherein, for each display panel of the plurality of display panels, the DMA controller further to perform:
reading a different respective strip of the third data stored in the memory, and
storing data of the different respective strip to a different respective buffer for the display panel.

16. The apparatus of claim 15, further comprising performing decimating operations on the first data to generate the third data.

17. The apparatus of claim 11, wherein the first data is provided from the GPE in a single graphics render output.
